(19) United States
(12) Patent Application Publication
(10) Pub. No.: US 2014/0280272 A1
(43) Pub. Date: Sep. 18, 2014

(54) MEDIA CONTENT SUBSTITUTION

(71) Applicant: International Business Machines Corporation, Armonk, NY (US)

(72) Inventors: Omar Florez CHOQUE, San Jose, CA (US); John Bernard GEAGAN, III, San Jose, CA (US); Dulce B. PONCELEON, Palo Alto, CA (US)

(73) Assignee: INTERNATIONAL BUSINESS MACHINES CORPORATION, Armonk, NY (US)

(21) Appl. No.: 13/843,185

(22) Filed: Mar. 15, 2013

(51) Int. Cl. G06F 17/30

(52) U.S. Cl. CPC G06F 17/30023
USPC 707/758

(57) ABSTRACT

Embodiments of the invention relate to managing access to media files and content therein. In one embodiment, a first identifier representing a first media content component in a first set of media content components is identified. The first set of media content components is included within a first media file that has been received from a first source. The identifier is compared with at least a second identifier representing at least a second media content component in a second set of media content components. The second set of media content components is associated with at least a second media file received from a second source. The first source is different than the second source. Responsive to the first digital signature substantially matching the second identifier, the first media content component is replaced with the second media content component.

### BACKGROUND

Embodiments of the present invention generally relate to media management, and more particularly relate to substituting media content within a media file based on the characteristics/attributes associated therewith.

Media content such as video and audio content has become increasingly accessible over the recent years. Users are able to download or stream content from a variety of sources to numerous devices. One problem experienced by users is that the quality of the media content may be of poor quality and/or may not have the proper licenses associated therewith. This can lead to a poor user experience with respect to the media content being accessed by the user.

### BRIEF SUMMARY

In one embodiment a method is disclosed. The method comprises identifying a first identifier representing a first media content component in a first set of media content components. The first set of media content components is included within a first media file that has been received from a first source. The first identifier is compared with at least a second identifier representing at least a second media content component in a second set of media content components. The second set of media content components is associated with at least a second media file received from a second source. The first source is different than the second source. Responsive to the first identifier substantially matching the second identifier, the first media content component is replaced with the second media content component.

In another embodiment, a method is disclosed. The method comprises receiving a first set of identifiers. Each of the first set of identifiers corresponds to at least a portion of a media content component of a media file. Each of the first set of identifiers is compared with a second set of identifiers. Each of the second set of identifiers corresponds to at least a portion of a media content component of an available media file. A determination is made, based on the comparison, that at least a first identifier in the first set of identifiers matches a second identifier in the second set of identifiers. The first identifier is replaced with the at least the portion of the media content component corresponding to the second identifier based on the determination.

In a further embodiment, a computer program product is disclosed. The computer program product comprises a computer readable storage medium having program code embodied therewith. The program code is readable/executable by a processor to identify a first identifier representing a first media content component in a first set of media content components. The first set of media content components is included within a first media file that has been received from a first source. The first identifier is compared with at least a second identifier representing at least a second media content component in a second set of media content components. The second set of media content components is associated with at least a second media file received from a second source. The first source is different than the second source. Responsive to the first identifier substantially matching the second identifier, the first media content component is replaced with the second media content component.

In yet another embodiment, a system is disclosed. The system comprises a memory and a processor that is communicatively coupled to the memory. A media manager is communicatively coupled to the memory and the processor. The media manager is configured to perform a method. The method comprises receiving a first set of identifiers. Each of the first set of identifiers corresponds to at least a portion of a media content component of a media file. Each of the first set of identifiers is compared with a second set of identifiers. Each of the second set of identifiers corresponds to at least a portion of a media content component of an available media file. A determination is made, based on the comparison, that at least a first identifier in the first set of identifiers matches a second identifier in the second set of identifiers. The first identifier is replaced with the at least the portion of the media content component corresponding to the second identifier based on the determination.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 is a block diagram illustrating one example of an operating environment according to one embodiment of the present invention;

FIG. 2 illustrates one example of an external media file according to one embodiment of the present invention;

FIG. 3 illustrates one example of identifiers for media content components according to one embodiment of the present invention;

FIG. 4 shows the external media file after one or more media components therein have been substituted with one or more media components that are local to a user system according to one embodiment of the present invention;

FIG. 5 illustrates one example of a transactional diagram for substituting media content within a media file based on the characteristics/attributes associated therewith according to one embodiment of the present invention;

FIG. 6 illustrates one example of an identifier-based playlist/mashup according to one embodiment of the present invention;

FIG. 7 is an operational flow diagram illustrating one example of a process for substituting media content within a media file based on the characteristics/attributes associated therewith according to one embodiment of the present invention;

FIG. 8 is an operational flow diagram illustrating one example of a process for substituting media content identifiers within an identifier-based playlist/mashup with corresponding media content components/files substituting media content identifiers within an identifier-based playlist/mashup with corresponding media content components/files; and

FIG. 9 is a block diagram illustrating a detailed view of an information processing system according to one embodiment of the present invention.

### DETAILED DESCRIPTION

FIG. 1 shows one example of an operating environment 100 applicable to various embodiments of the present invention. In one embodiment, a plurality of information processing systems 102, 104, 106 are communicatively coupled to one or more networks 108, which can comprise wired and/or wireless networks. In this embodiment, the plurality of information processing systems comprises one or more user systems 102, one or more media servers 104, and one or more optional digital rights management servers 106. The user system 102, in one embodiment, can include any one of (or a combination of) the following: a desktop computing system, a laptop/notebook computing system, a tablet computing device, a wireless communication device, a gaming unit, a Personal Digital Assistant, and other electronic devices.

The user system 102, in one embodiment, comprises a media manager 110, local media files 112 comprising local media content components 113, digital media content identifiers (IDs) 114, one or more media clients 116, and optional licenses 118. As will be discussed in greater detail below, the media manager 110 manages media content and its presentation to a user via the media client 116. The media content components 113 can be media content within a local media file 112 stored on the user system 102 (or on a storage device/system communicatively coupled to the user system 102) and/or media content items 121 within an external media file 120 stored on the media server 104 (or any other system).

The external media file 120 can be downloaded locally to the user system 102 and/or streamed to the user system 102 for presentation to the user via the media client 116. The media client 116 can be any local or network based application such as a media player, plug-in, etc. that allows a user to view/hear and/or interact with the media content components 113, 121. The media content items/components 113, 121 can be any type of media component such as text, audio, video, and/or a combination thereof. In addition to the external media file 120, the media server 104 (or any other system) can comprise identifier-based playlist/mashup files 123, which are lists or groupings of media content identifiers. Identifier-based playlist/mashup files 123 are discussed in greater detail below.

In one embodiment, the media manager 110 transforms or modifies media content components or portions thereof from a first source (e.g., media server 104) with media content components or portions thereof from a second source (e.g., user system 102) based on the attributes/characteristics associated therewith. For example, the media manager 110 is able to transform/modify one or more media content components 121 within an external media file 120 with one or more media content components 113 residing locally at the user system 102 or at another system communicatively coupled to the user system 102. The transformation/modification process can include generating an entirely new media file (or generating an updated original media file) comprising the substituted local media content components or linking the external media file and local media content while keeping the media components from the different sources separate from each other. The media manager 110 comprises an identifier generator (or manager) 122, a comparator 124, a media analyzer 126, and a media modifier 128. Each of these components is used by the media manager 110 to perform the transformation/modification process discussed above. The media manager 110 and its components are discussed in greater detail below.

The optional licenses 118 are associated with the local media content 112 and indicate, among other things, whether or not the user has been granted permission by a licensor to interact with the associated media content. The license 118 can identify the type of actions (e.g., listen, view, recreate, distribute, etc.) a user can perform with respect to media content. The media manager 110 can utilize the licenses 118 to ensure that the user is authorized to interact with the either the local media files 112 or external media files 120 (e.g., media files from a difference source than the user system 102). Licenses 118 can also identify media components that the user is required to purchase in order to access the external media file 120. In another embodiment, the licenses 118 are utilized by a digital rights manager 130 residing at the DRM server 106 to determine if the user is authorized to interact with the media content 112 and to also identify which actions are authorized.

The licenses 118 can also payment information as well. For example, the licenses can identify the entity to which payment is to be sent as a result of the user accessing the local media content 112). Payment information can also indicate how a payment is to be sent, where a payment is to be sent, and any other information for facilitating a payment to the entity. It should be noted that payment information is not required to reside within a license.

In an embodiment where a DRM server 106 is utilized, the media manger 110 can communicate with the DRM manager 130 prior to replacing/substituting external media content components (or portions thereof) with local media content components (or portions thereof) to determine if the user is authorized to interact with any of the components. It should be noted that in embodiments where DRM is implemented, the DRM manager 130 can reside within the user system 102 as well. In yet another embodiment, the licenses 118 can be stored at the DRM server 106 and/or the media server 104. In addition, the media manager 110 can also reside at the DRM server 106 and/or the media server 104. The media file transformation/modification processes can then occur at one of these servers and the transformed/modified media content can be downloaded or streamed to the user system 102.

The following is a more detailed discussion on substituting media content components from a first source (e.g., media server 104) with media content at a second source components (e.g., user system 102). In one embodiment, the media manager 110 is configured to detect when the user has downloaded an external media file 120 from the media server 104, detect when the user is about to start (or has begun) viewing media content 121 obtained from an external media file 120, and/or detect when streaming of the media content 121 from an external media file 120 has begun. The media analyzer 126 of the media manager 110 analyzes the media content component(s) 121 of the external media file 120 to determine the various types of media associated therewith such as, audio, text, video, etc.

For example, FIG. 2 shows one example of an external media file 202 comprising media content 204. In particular, FIG. 2 shows that the external media file 202 comprises a plurality of video components 206, 208, 210; a plurality of audio components 212, 214, 216; and a text component 218. In this example, the external media file 202 is a mashup where each of the media components (e.g., video and audio components) is a portion or clip taken from one or more media sources (e.g., video and audio files, respectively. However, it should be noted that the external media file 202 is not limited to a mashup and can be a single video file, a single audio file, a combination thereof, etc. The media analyzer 126 analyzes the media file 202 and identifies each of the media components 206, 208, 210, 212, 214, 216, 218 within the media file 202 and their media types.

In addition to determining the various types of media associated with external media file, the media analyzer 126 also identifies the attributes/characteristics associated therewith. The attributes/characteristics of a media file and/or the media content within the file can be, but is not limited to, copyright and licensing information, quality information (e.g., resolution, bit rate, stereo, mono, etc.), length information, etc. In one embodiment, the copyright information can indicate whether users can view, recreate, or distribute the media file and/or the media content therein.

Once the media content components and their associated attributes/characteristics are identified, the media manager 110 can decide whether or not to transform/modify the external media file 120 by replacing/substituting one or more of the media content components 121 therein with one or more of the user's local media content 113 (if available). For example, the media manager 110 can be configured with default media management parameters and/or user defined media management parameters that are utilized by the media manager 110 to determine when and how media content 121 from a source other than the user system is to be replaced. For example, one default parameter (and/or user defined parameters) can include one or more copyright-based conditions. These conditions can indicate that whenever copyrighted content is detected within the media file 121 and the user does not have the proper license(s) to interact with this media content that this content is to be replaced with local media content components 113 (if available). If the external media file 120 comprises video content the media manager 110 searches the user's local media content for substantially similar video content to replace the video content in the external media file 120. For example, if an external media file cannot be viewed by a user through a given service in a given country, the media manager 110 can substitute the non-accessible content in the external media file with a user's corresponding local media content.

User-defined parameters (or default parameters) can include conditions such as quality conditions (e.g., resolution, bit rate, stereo, mono, etc.), length conditions, etc. that the media content 121 within the external media file 120 needs to satisfy. If these conditions are not met, then the media manager 110 determines that this media content needs to be replaced with local media content 113 that satisfies these conditions. For example, a user defined parameter can indicate that the resolution of video content needs to be above a given threshold. Therefore, if the resolution of video content in an external media file 120 is below this threshold, the media manager 110 determines that this video content needs to be replaced with local video content that is above the user-defined threshold. Another user-defined parameter can indicate that if the quality of audio content within an external media file 120 is below a given threshold that the media manager 110 is to replace this audio content with audio content from the user's local media content 113 that is above this user-defined threshold. It should be noted that user-defined parameters can be used as default parameters and can also be used in combination with default parameters (e.g., identifying media content with a proper license that has video resolution above a user-defined threshold).

In one embodiment, the media manager 110 replaces/substitutes media content components 121 within the external media file 120 with substantially similar media content from the user's local media content 113 for which the user has an appropriate license for. In one embodiment, the licensing requirement is optional. The media manager 110 can determine the similarity between external media content components 121 and the local media content components 113 in various ways. In one embodiment, the media manager 110 utilizes identifiers representing (or associated with) the media content components 113, 121 to determine the similarity therebetween.

The media file 112, 120 can comprise the identifiers of its media content files and/or the identifier generator 122 of the media manager 110 can compute or generate the identifier if needed. Identifiers can include (but not limited to) signatures/fingerprints, hashes, checksums, byte lengths, content titles, or any data that can be used for identifying media content. A signature/fingerprint of media content is a condensed digital summary that is deterministically generated from the media content. In one example, a signature/fingerprint can comprise a vector of various dimensions associated with the media content components 113, 121. In one embodiment, media content can be associated with different identifiers. For example, a first source (e.g., publisher, provider, owner, licensee, etc.) of a media file may associate a first identifier with a media content item within the file, while a second source may associate a second identifier with the media content item.

In one embodiment, the identifier generator 122 of the media manager 110 extracts the media content 113, 121 from the media file 112, 120 (if required) to obtain identifier(s) 114 of the media content 113, 121. For example, if the media file 112, 120 comprises both audio and video media content, the audio and video content are extracted into separate files. The identifier generator 122 then computes or generates the identifier 114 of the extracted media content 113, 121. In one embodiment, the identifier 114 is generated/determined based on metadata associated with the media content 113, 121 and/or its media file 112, 120. Non-limiting examples of metadata are title, publisher, play length, album, artist, description, etc. associated with the content and/or its media file.

In an embodiment where the identifier is a signature/fingerprint the identifier generator 122 takes into account the perceptual characteristics of the media content. In other words, if two media content files are visually and/or audibly similar to a human's senses then their signatures/fingerprints should match or at least be substantially similar regardless of their binary representations. Also, small variations in the data can be tolerated by the signature/fingerprint computation process. In other words, if the media content is changed in an insignificant way (or even compressed), the signature/fingerprint computed for the modified media content matches the original media content.

Once the identifier(s) for the external media content component 113 has been computed/obtained the comparator 124 of the media manager 110 compares this identifier to the identifiers 114 of the user's local media content components 113 to identify a matching or substantially similarly set of media content components. For example, FIG. 3 shows one example of an identifier 302 calculated for a media content component 121 of an external media file 120 and a plurality 304 of identifiers associated with local media content components 113 on (or coupled to) the user system 102. In this example, the identifiers are signatures/fingerprints; however, other identifiers are applicable as well. Also, the format and content of the signatures/fingerprints shown in FIG. 3 are for illustrative purposes only and do not limit embodiments of the present invention. For example, the signatures/fingerprints are not limited to being represented by bits and can be represented by spectrograms, graphs, waveforms, etc.

In the example of FIG. 3, the media manager 104 determines that there is a 100% match or confidence for the similarity between these two media content components based on comparing the identifier 302 of the eternal media content to the first local media content signature/fingerprint 306. In other words, every bit in the first local media content signature/fingerprint 306 matches every bit in the signature/fingerprint 302 of the external media component. A 100% match can indicate that the two media components are exactly the same or vary in an insignificant way. The media manager 110 also determines that there is a 93.75% match (e.g., 15 out of 16 bits match) between the second local media content signature/fingerprint 208 and the external media content signature/fingerprint 302. A close match such as a 93.75% match can indicate that the two media components are, for example, the same song, but vary slightly. This variation can be in duration, venue (e.g., live recording vs. a studio recording), etc.

The media manager 110 further determines that there is 68.75% match (e.g., 10 out of 16 bits match) between the third local media content signature/fingerprint 210 and the external media content signature/fingerprint 302. Based on the comparison to the fourth local media content signature/fingerprint 312, the media manager 110 determines that there is 0% match (e.g., 0 out of 16 bits match) between the fourth local media content signature/fingerprint 312 and the external media content signature/fingerprint 302. A very low percentage or null percentage match indicates that the two media components are not the same (e.g., different songs or videos).

In one embodiment, the media manager 110 automatically selects the local media content component 113 with the highest matching signature/fingerprint that is above a given threshold/tolerance to replace the external media component 121. For example, the threshold/tolerance can indicate that the match is required to be above 90% for selecting a local media content component 113 to replace the external media content component 121. Therefore, the media manager 110 selects the local media content component 113 with the highest matching signature/fingerprint that is above a 90% match/confidence. In another embodiment, the user can be prompted to select from each of the local media content components 113 that match above the given threshold. If the media manager 110 cannot identify a local media content component 113 that matches the external media component 121 at least within a given threshold, the media manager 110 notifies the user and can either disallow the playback of the external media file 120 or allow playback of the original external media file 120 without any transformation/modification operations being performed thereon. It should be noted that the user can also be prompted to purchase any external media content component 121 without a local match. The purchased media content component is then stored locally on the user system 102 (or on a system coupled to the user system 102).

In embodiments where the user has set one or more parameters governing the types of local media content components 113 that are to be selected for replacing/substituting the external media content component 121 the media manager 110 not only identifies local media content component 113 that matches the external media content component 121 (at least within a given threshold), but that also satisfies the conditions set forth in the user-defined parameters. For example, if the user defines a parameter that indicates a local media content component 113 with a higher (or lower) bit rate is to be selected the media manager 110 identifies a local media content component 113 that matches the external media content component 121 (at least within a given threshold) and that also satisfies the bit rate condition as defined by the user. If a local media content component 113 that satisfies the user defined condition cannot be found, the media manager 110 can notify the user, play the original external media file 120, disallow playback of the external media file 120, or present a the list of local media content components 113 that match the external media content component 121 (but fail to meet the user-defined condition). In an embodiment where the licenses 118 are utilized, the media manager 110 analyzes the licenses 118 associated with the local content to ensure that the user is authorized to view/interact with the local media content component.

Once the media manager 110 identifies the appropriate local media content component 113 the media modifier 128 of the media manager 110 replaces the media content component within the external media file 120 with the identified local media content component 113. FIG. 4 shows one example where the media components of the external media file 202 of FIG. 2 have been substituted with identified local media content components. For example, FIG. 4 shows that a video component V_{—}2 208 in the external media file 202 has been replaced with a local video component LV_{—}2 408. FIG. 4 also shows that the audio component A_{—}2 214 in the external media file 202 has been replaced with a local audio component LA_{—}2 414. It should be noted that a local media content component can be a full/complete version of a media source (e.g., audio file(s), movie file(s), etc.) comprising the media content component to be replaced. In this example, if the media content component to be replaced is only a portion/clip of the full version then the media manager 110 only uses the corresponding portion of the local media content component to replace the media content component in the external media file.

Therefore, when the external media file 202 is presented to the user via the media client 116 the local media content component 113 is presented to the user instead of the original eternal media content component 121. In another embodiment, the media manager 110 generates an entirely new file using the non-substituted media content components and the identified local media content components. This new media file is then presented to the user via the media client 116. Alternatively, the non-substituted media content components and the identified local media content components are kept separate from each other. It should be noted that the non-substituted media content components and/or the local media components can be transformed to enhance the user experience of the modified external media file. For example, the local media component being substituted into the external media file 120 may not be an exact match to the original media component. This can occur, for example, if audio corresponding to video is being replaced. The original audio may have been a live recording with poor audio quality, whereas the local audio component may be a studio recording with higher quality audio. Therefore, the substituted audio may not match the video perfectly. In this situation, the media manager 110 can modify the video or audio to provide better synching therebetween. For example, the playback of the audio or video can be increased, decreased, etc.

FIG. 5 shows a transactional diagram illustrating the above process. An external media file 502, at T1, is received by the media manager 110 at the user system 102. The external media file 502 in this example comprises audio 504, video 506, and text 508 media content components. The media analyzer 126, at T2, analyzes the media file 502 to identify the various media content components 504, 506, 508. The media analyzer 126, at T3, determines if the characteristics/attributes associated with each of the media components 504, 506, 508 satisfies a replacement/substitution condition or parameter, as discussed above. If so, the identifier generator 122, at T4, extracts at least a portion of the identified media content component 506 (or all media components) from the media file 502 and calculates the identifier 510 of the extracted component 506 at T5. In the example, of FIG. 5, the audio content component 506 had a bit rate that was lower than a threshold set by a user. Therefore, the media manager 110 determines that this audio content component 506 needs to be replaced/substituted.

The comparator 124, at T6, compares the identifier 510 of the audio content component 506 to the identifier 312 of the user's local media content components. The local identifiers 114 can be located using an index into a database storing the identifiers or by any other method. Once the media manager 110 identifies, at T7, a local media content component 312 that is substantially similar (at least within a given threshold/tolerance) to the audio content component 306 based on the comparison process, the media manager 110, at T8, encodes the original content components 504, 508 within the external media file 502 that are not being replaced and the identified local media content component into a new media file 514. As can be seen in FIG. 5, this new media file 514 comprises the original video and text components 504, 508, but the original audio content component 506 has been replaced with the user's local audio content component 512.

In addition to identifying matching local media components using identifiers, the media manager 110 can also identify additional content that is relevant to the external media content component or portions thereof. For example, if the external media file 120 is a movie the media manager 110 can identify attributes of the movie such as location information, product information, etc. based on the signatures/fingerprints of the video and/or audio components of the movie. The media manager 110 can then identify corresponding information, products, etc. associated with the identified attributes that are available to the user. For example, if the identified attributes are locations within a movie, the media manager 110 can identify books, articles, websites, etc. corresponding to these identified locations. The user can be presented within this information during the movie (e.g., when an identified location is being displayed) or at any other point in time.

The media manager 110 can also use media content identifiers to identify portions of media that have attributes that are to be replaced. For example, a parent can set parameters (e.g., parental control requirements) that instruct the media manager 110 to identify explicit words within a song, explicit scenes within a movie, etc. The media manager 110 can identify these attributes based on the signatures/fingerprints computed for the media. When a portion of the song or movie comprising these attributes is identified, the media manager 110 can replace the identified portions with more appropriate content, which can be defined by the user or the media manager 110. Alternatively, these portions can be deleted or “whited out” (e.g., made incomprehensible).

In another embodiment, if an external media file 120 is a paper comprising citations, the media manager 110 links the citations to a user's local set of papers that match the citations. For example, the media manager 110 can analyze the paper to identify each citation. Based on the information in the citations such as, but not limited to, author information, title information, publication information, etc. the media manager 110 can identify locally stored papers that match the citations. The media manager 110 can then modify the paper to include hyperlinks for each citation that link to the user's locally stored papers. When the user selects a hyperlink within the paper the locally stored paper can be displayed to the user.

In a further embodiment, a proxy can be used to disallow direct access of clients to unlicensed media on Internet. For example, this proxy can be configured to compute media signatures/fingerprints and check if the current licenses grant access to the media file. This can help prevent users from using pirated media. A proxy can also be used to cache licenses already purchased for content. This enables a server to store copies of downloaded media acquired legally. When a computer in a local network purchases content from Internet, the copy of the licensed media is stored in the server. Subsequently, when another computer from the local network requests for media of similar content, the proxy can automatically replace it with the stored copy instead of purchasing the original one again or using illegal copies.

In another embodiment, the media manager 110 substitutes a media component 121 of an external media file 120 associated with a first language with a local media component 113 associated with a second language. For example, the media manager 110 can obtain the identifier corresponding to the external media component 121 as discussed above. The media manager 121 then compares this identifier to its local media content identifiers 114. If a match is found the media manager 110 analyzes the matching local media content identifier 114 to determine if it is associated with any other identifiers or content/files. For example, an identifier can be associated with metadata comprising identifiers corresponding to other versions of the media component/file. The media manager 110 analyzes these other identifiers or media content components/files to identify a given version, such as a different language version, of the external media component 121. If a version is identified the media manager 110 substitutes the external media component 121 with the identified media component/file. If a version of interest is not available locally, the media manager 110 can perform a similar search on remote systems and/or download the required version for substitution with the external media component 121.

It should be noted that one or more embodiments discussed above are also applicable to identifier-based playlists/mashups as well. FIG. 6 shows one example of an identifier-based playlist/mashup file 600 comprising a plurality of media content identifiers 602. The identifier-based playlist/mashup 600, in this embodiment, does not comprise any media content components/files. However, in another embodiment, the playlist/mashup 600 comprises both media content identifiers 602 and media content components/files. In this embodiment, the media content identifiers 602 are associated with media content components/files external to the playlist/mashup 600.

In a playlist embodiment, each of the identifiers 602 corresponds to a separate media file such as (but not limited to) an audio file. In a mashup embodiment, the identifiers 602 correspond to media components from various media files such as (but not limited to) which can be of the same type or different types. A media component within a mashup can be a clip or portion of a media component, a media component in its entirety, etc. For example, a mashup can include 10 seconds of video from a first video file, 5 minutes of video from a second video file, and an audio file in its entirety, and is presented to the user as a single media file.

In one embodiment, the user system 102 receives the playlist/mashup 600 from the media server 104 or from any other source. The media manager 110 analyzes the playlist/mashup 600 and identifies each of the identifiers 602 within the playlist/mashup 600. The media manager 110 compares each of the playlist/mashup identifiers 602 from with the local media content identifiers 114. The media manager 110 then determines if any of the local media content identifiers 114 match any of the playlist/mashup identifiers 602. If so, the media manager 110 determines that the user system 102 comprises (or is coupled to) local media content components 113 (or files 112) corresponding to the playlist/mashup identifiers 602. The media manager 110 substitutes the playlist/mashup identifiers 602 with the local media content components 113 (or files 112) similar to the substitution operations discussed above.

If the media manager 110 determines that a match does not exist for a playlist/mashup identifier 602 the media manager 110, in one embodiment, notifies the user. The user can then obtain the corresponding media content component (or file) from one or more sources. However, even when no local identifiers 114 match a playlist/mashup identifier 602, a corresponding local media content component 113 (or file 112) may still be available. For example, different sources of media files/content can provide different identifiers for the same media files/content. Stated differently, a non-matching local identifier and the playlist/mashup identifier may correspond to the same media content component (or file).

Therefore, in one embodiment, if a local match does not exist for a playlist/mashup identifier 602 the media manager 110 queries the external source associated with the playlist/mashup identifier 602 to identify the corresponding media content component (or file). In this embodiment, the media manager 110 identifies the external source by maintaining a record from where the playlist/mashup was obtained from. Alternatively, source information is included as part of the playlist/mashup identifiers 602 (or at least is included within the playlist/mashup 600). The source sends the media manager 110 an information set associated with the unmatched playlist/mashup identifier(s) 602. This information set can include metadata such as (but not limited to) the title, artist, album, chapter, time range, etc. associated with the media content component (or file) corresponding to the identifier(s) 602. For example, if the playlist/mashup identifier 602 is associated with a given song file, the source can send the media manager 110 the title, album, and artist information associated with song.

The media manager 110 utilizes this information set to determine if any local media content components/files have metadata matching this received information. If so, the media manager 110 determines that a corresponding local media content component/file is available even though its local identifier does not match the corresponding playlist/mashup identifier. The media manager 110 records the playlist/mashup identifier 602 originally determined to be unmatched for future reference. The media manager 110 also identifies the local identifier associated with the corresponding local media content component/file and maps/associates the recorded playlist/mashup identifier 602 to the local identifier.

In another embodiment, one or more identifier databases (not shown) are communicatively coupled to the user system 104 that comprise mapping information between different identifiers for given media content components/files. These databases can be maintained by various users and/or media component sources. In this embodiment, once the media manager 110 determines that none of its local media content identifiers match a playlist/mashup identifier 602 the media manager 110 queries one or more identifier databases for alternative identifiers associated with the playlist/mashup identifier 602. The media manager receives one or more alternative identifiers associated with the playlist/mashup identifier 602 from the queried identifier database(s).

The media manager 110 compares each of these alternative identifiers to its local media content identifiers 114 and determines if a match exists. If a match does exist, the media manager 110 determines that a local media content component 113 (or file 112) corresponding to the playlist/mashup identifier 602 is available. The media manager 110 also records the playlist/mashup identifier 602 and its alternative identifiers for future reference. The media manager 110 then maps/associates each of the recorded identifiers to the matching local media content identifier. If the media manager 110 determines that a local media content component 113 (or file 112) corresponding to the playlist/mashup identifier 602 is not available, the user is presented with an option to download the corresponding media content component/file from one or more sources.

Once the corresponding local media content components/files have been identified (or obtained), the media manager 110 performs one more substitution operations similar to those discussed above. For example, the media manager substitutes each identifier 602 within the playlist/mashup 600 with its corresponding local media content component 113 (or file 112). The media client 116 processes the playlist/mashup 600 comprising the substituted components/files and presents the components/files to the user. It should be noted that media manager 110 can also generate a new file comprising the substituted components/files or pointers to the locally stored media content components/files. It should be noted that if one or more local media content/files 113 are not available for one or more identifiers within the local media content/files 113 the media client 116 can still present the local media components/files to the user that have been substituted into the playlist/mashup 600.

Referring now to FIG. 7, the flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

FIG. 7 is an operational flow diagram illustrating one example of a process for substituting media content within a media file based on the characteristics/attributes associated therewith. The operational flow of FIG. 7 starts at step 702 and flows directly into step 704. The media manager 110, at step 704, receives a first media file 120 from a first source 104. The media manager 110, at step 706, identifies a first set of media content components 121 within the first media file 120.

The media manager 110, at step 708, compares at least a portion of one media content component in the first set of media content components 121 to at least one media management parameter. The media manager 110, at step 710, determines if the parameter is satisfied. If the result of this determination is positive, the control flow exits at step 712. If the result of this determination is negative, the media manager 110, at step 714, identifies a first digital signature/fingerprint of at least the portion of the media content component. The media manager 110, at step 716, compares the first digital signature/fingerprint to at least a second digital signature/fingerprint representing at least a portion of a second media content component 113 from a second media file 112 at a second source 102. The media manager 110, at step 718, determines if there is a match. If the result of this determination is negative, the media manager 110, at step 720, notifies the user and the control flow exits at step 722. If the result of this determination is positive, the media manager 110, at step 724, replaces at least the portion of first media content component in the first media file 120 with at least the portion of the second media content component 113 from the second source 102. The control flow then exits at step 726.

FIG. 8 is an operational flow diagram illustrating one example of a process for substituting media content identifiers within an identifier-based playlist/mashup with corresponding media content components/files. The operational flow of FIG. 8 starts at step 802 and flows directly into step 804. The media manager 110, at step 804, receives a first set of media content identifiers 125. Each of the first set of identifiers 125 corresponds to at least a portion of a media content component of a media file. In one embodiment, the first set of identifiers 125 is received from a system 104 that is separate and distinct from the system 102 comprising the media manager 110.

The media manager 110, at step 806, compares each of the first set of media content identifiers 125 with a second set of media content identifiers 114. Each the second set of media content identifiers 114 corresponds to at least a portion of a media content component 113 of a media file 112 available to user system 102 comprising the media manager 110. The media manager 110, at step 808 determines, based on the comparing, that at least a first media content identifier in the first set of media content identifiers 125 matches a second media content identifier in the second set of media content identifiers 114. The media manager 110, at step 810, replaces the first media content identifier with the at least the portion of the media content component corresponding to the second media content identifier. The control flow then exits at step 812.

Referring now to FIG. 9, this figure is a block diagram illustrating an information processing system that can be utilized in embodiments of the present invention. The information processing system 900 is based upon a suitably configured processing system configured to implement one or more embodiments of the present invention (e.g., the user system 102 of FIG. 1). Any suitably configured processing system can be used as the information processing system 900 in embodiments of the present invention.

The information processing system 900 includes a computer 902. The computer 902 has a processor(s) 904 that is connected to a main memory 906, mass storage interface 908, and network adapter hardware 910. A system bus 912 interconnects these system components. Although only one CPU 904 is illustrated for computer 902, computer systems with multiple CPUs can be used equally effectively. The main memory 906, in this embodiment, comprises the media manager 110 and its components, as well as other items (not shown such as the local media files 112, local media content components 113, digital media content signatures 114, one or more media clients 116, and optional licenses 118.

The mass storage interface 908 is used to connect mass storage devices, such as mass storage device 914, to the information processing system 900. One specific type of data storage device is an optical drive such as a CD/DVD drive, which can be used to store data to and read data from a computer readable medium or storage product such as (but not limited to) a CD/DVD 916. Another type of data storage device is a data storage device configured to support, for example, NTFS type file system operations.

An operating system included in the main memory is a suitable multitasking operating system. Embodiments of the present invention are also able to use any other suitable operating system. Some embodiments of the present invention utilize architectures, such as an object oriented framework mechanism, that allows instructions of the components of operating system to be executed on any processor located within the information processing system 900. The network adapter hardware 910 is used to provide an interface to a network 108. Embodiments of the present invention are able to be adapted to work with any data communications connections including present day analog and/or digital techniques or via a future networking mechanism.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit”, “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been discussed above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments above were chosen and described in order to best explain the principles of the invention and the practical application, and to enable others of ordinary skill in the art to understand the invention for various embodiments with various modifications as are suited to the particular use contemplated.

What is claimed is:

1. A method, comprising:
identifying a first identifier representing at least a portion of a first media content component in a first set of media content components, wherein the first set of media content components is included within a first media file that has been received from a first source;
comparing the first identifier with at least a second identifier representing at least a portion of a second media content component in a second set of media content components, wherein the second set of media content components is included within at least a second media file received from a second source, wherein the first source is different than the second source; and
replacing the at least a portion of the first media content component with the at least a portion of the second media content component based on the first identifier substantially matching the second identifier.

2. The method of claim 1, wherein the identifying is based on:
analyzing the first set of media content components;
comparing each media content component in the first set of media content components to at least one media management parameter; and
determining that the first media content component fails to satisfy the media management parameter.

3. The method of claim 2, wherein the second media content component satisfies the media management parameter.

4. The method of claim 2, wherein the media management parameter comprises at least one of:
a licensing requirement;
a video quality requirement;
an audio quality requirement; and
a parental control requirement.

5. The method of claim 1, wherein first and second set of media content components each comprise at least one of:
a video media component;
an audio media component; and
a textual media component.

6. The method of claim 1, wherein the first source is a media server, and wherein the second source is a user system, wherein the media server is remote from the user system.

7. The method of claim 1, further comprising:
presenting the first media file to a user with at least the portion of the first media content component having been replaced with at least the portion of the second media content component.

8. The method of claim 1, wherein first media file is a mashup comprising a plurality of media components from one or more media sources.

9. The method of claim 1, wherein the wherein the second media file is a full version of one of the one or more media sources comprising at least a portion of a first media content component.

10. The method of claim 1, wherein the at least a portion of the second media content component is one of a higher quality version and a lower quality version of the at least a portion of the first media content component.

11. A method comprising:
receiving a first set of identifiers, wherein each of the first set of identifiers corresponds to at least a portion of a media content component of a media file;
comparing each of the first set of identifiers with a second set of identifiers, wherein each of the second set of identifiers corresponds to at least a portion of a media content component of an available media file;
determining, based on the comparing, that at least a first identifier in the first set of identifiers matches a second identifier in the second set of identifiers; and
replacing, based on the determining, the first identifier with the at least the portion of the media content component corresponding to the second identifier.

12. The method of claim 11, wherein the first set of identifiers is included within one of a playlist file and a mashup file.

13. The method of claim 12, wherein the replacing comprises:
replacing the first identifier within the one of the playlist file and the mashup file with the at least the portion of the media content component.

14. The method of claim 11, further comprising:
presenting the first set of identifiers to a user with the first identifier having been replaced with the at least the portion of the media content component.

15. The method of claim 11, further comprising:
determining that at least a third identifier in the first set of identifiers fails to match each identifier in the second set of identifiers;
querying at least one database for alternative identifiers associated with the second set of identifiers; and
receiving, from the database, at least one alternative identifier associated with the second set of identifiers.

16. The method of claim 15, further comprising:
comparing the at least one alternative identifier to each of the second set of identifiers.

17. The method of claim 16, further comprising:
determining, based on the comparing, that the alternative identifier matches a fourth identifier in the second set of identifiers; and
replacing, based on the determining, the third identifier in the first set of identifiers with the at least the portion of the media content component corresponding to the fourth identifier.

18. A computer program product, the computer program product comprising a computer readable storage medium having program code embodied therewith, the program code readable/executable by a processor to:
identify a first identifier representing at least a portion of a first media content component in a first set of media content components, wherein the first set of media content components is included within a first media file that has been received from a first source;
compare the first identifier with at least a second identifier representing at least a portion of a second media content component in a second set of media content components, wherein the second set of media content components is included within at least a second media file received from a second source, wherein the first source is different than the second source; and
replace the at least a portion of the first media content component with the at least a portion of the second media content component based on the first identifier substantially matching the second identifier.

19. The computer program product of claim 18, wherein the program code is further readable/executable by the processor to:
present the first media file to a user with at least the portion of the first media content component having been replaced with at least the portion of the second media content component.

20. A system, comprising:
a memory;
a processor communicatively coupled to the memory; and
a media manager communicatively coupled to the memory and the processor, wherein the media manager is configured to perform a method comprising:
receiving a first set of identifiers, wherein each of the first set of identifiers corresponds to at least a portion of a media content component of a media file;
comparing each of the first set of identifiers with a second set of identifiers, wherein each of the second set of identifiers corresponds to at least a portion of a media content component of an available media file;
determining, based on the comparing, that at least a first identifier in the first set of identifiers matches a second identifier in the second set of identifiers; and
replacing, based on the determining, the first identifier with the at least the portion of the media content component corresponding to the second identifier.
